(19) United States
(12) Patent Application Publication
(10) Pub. No.: US 2002/0088178 A1
(43) Pub. Date: Jul. 11, 2002

(54) Hydrogen storage and generation system

(76) Inventor: David Wayne Davis, Little Rock, AR (US)

Correspondence Address: Mark Rogers, Speed & Rogers P.A., Suite 125, 1701 Centerview, Little Rock, AR, 72211, US

(21) Appl. No.: 09/758,633

(22) Filed: Jan. 10, 2001

(51) Int. Cl. B01J 7/02

(52) U.S. Cl. 48/61; 48/65; 48/204; 422/211; 422/239

(57) ABSTRACT

A hydrogen storage and generation system are disclosed. The fuel source of the present invention comprises a chemical hydride core, and an elongate, flexible moisture barrier encasing the core. The core may be formed by a plurality discrete bodies of NaH or NaBH₄, and the barrier may be a thermoplastic. A hydrogen generator of the present invention comprises a reaction chamber, a spool, and a fuel source wrapped around the spool, the fuel source comprising a chemical hydride core encased in an elongate moisture barrier. The generator also has means for removing the barrier from the core to permit the core to react with water or moisture in the reaction chamber. The generator may also have a second reaction chamber so that heat may be transferred from the first reaction chamber to the second reaction chamber for driving a reaction of Al and H₂O, thereby generating additional hydrogen.

### BACKGROUND OF THE INVENTION

This invention relates to hydrogen gas generation, and more particularly to a hydrogen generator and fuel source.

The alkali and water reaction to produce hydrogen has been commonly known for quite a long time for both fixed site and portable hydrogen gas generation. Previous efforts in the art have provided little or no insight or consideration for the convenient and safe handling of the various alkali and alkali metal compounds from producer to the end user. For many years sodium was widely used and handled in various containers from steel drums to railroad tankers to exclude moisture and oxygen which could result in uncontrolled decomposition from the reaction with moisture and oxygen in the atmosphere. Some early attempts at special packaging included wax coatings of small quantities in spheres.

More recently, U.S. Pat. Nos. 5,817,157 and 5,728,464 have proposed the encapsulation of small portions of sodium and other alkali and alkali compounds into spherical individual pellets. The contents of U.S. Pat. Nos. 5,817,157 and 5,728,464 are incorporated herein by reference. The pellets and machines disclosed for handling the pellets offer some advantages in fuel storage and transportation. Still, these pellets and machines suffer from a number of shortcomings. For example, the need to capture, position, and open each individual sphere adds to the cost and complexity of the system and may lead to reliability problems.

More commonly, hydrogen is stored and transported as a liquid in high pressure steel bottles or containers. This method of storage and transportation also suffers from a number of disadvantages. For example, liquefying hydrogen is energy intensive, containers capable of handling the necessary temperatures and pressures are bulky and heavy, and storing and transporting hydrogen in such high pressure containers can be hazardous.

### SUMMARY OF THE INVENTION

It is therefore an object of the present invention to provide a hydrogen generator and fuel source that are easy, safe, and economical to manufacture, store, transport, and use.

It is a further object of the present invention to provide a fuel source for a hydrogen generator that may be transported and stored on spools without the need for special containers or conditions.

It is a still further object of the present invention to provide a durable, reliable hydrogen generator of simple construction.

It is a still further object of the present invention to provide a hydrogen generator with improved hydrogen gas generation capabilities.

It is a still further object of the present invention to provide an improved method of generating hydrogen gas.

It is a still further object of the present invention to provide a method and system that uses energy from an exothermic reaction of a chemical hydride and water to drive an endothermic reaction for generating additional hydrogen gas.

Toward the fulfillment of these and other objects and advantages, a hydrogen generator and fuel source are disclosed. The fuel source of the present invention comprises a chemical hydride core, and an elongate, flexible moisture barrier encasing the core. The core may be formed by a plurality discrete bodies of NaH or NaBH₄, and the barrier may be a thermoplastic. A hydrogen generator of the present invention comprises a reaction chamber, a spool, and a fuel source wrapped around the spool, the fuel source comprising a chemical hydride core encased in an elongate moisture barrier. The generator also has means for removing the barrier from the core to permit the core to react with water or moisture in the reaction chamber. The generator may also have a second reaction chamber so that heat may be transferred from the first reaction chamber to the second reaction chamber for driving a reaction of Al and H₂O, thereby generating additional hydrogen gas.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is a partially exploded view of a fuel source of the present invention;

FIG. 2 is a sectional view of FIG. 1;

FIG. 3 is a partially exploded view of an alternate embodiment of a fuel source of the present invention;

FIG. 4 is a sectional view of FIG. 3; and

FIG. 5 is a schematic view of a hydrogen generator of the present invention.

### DETAILED DESCRIPTION OF THE PREFERRED EMBODIMENT

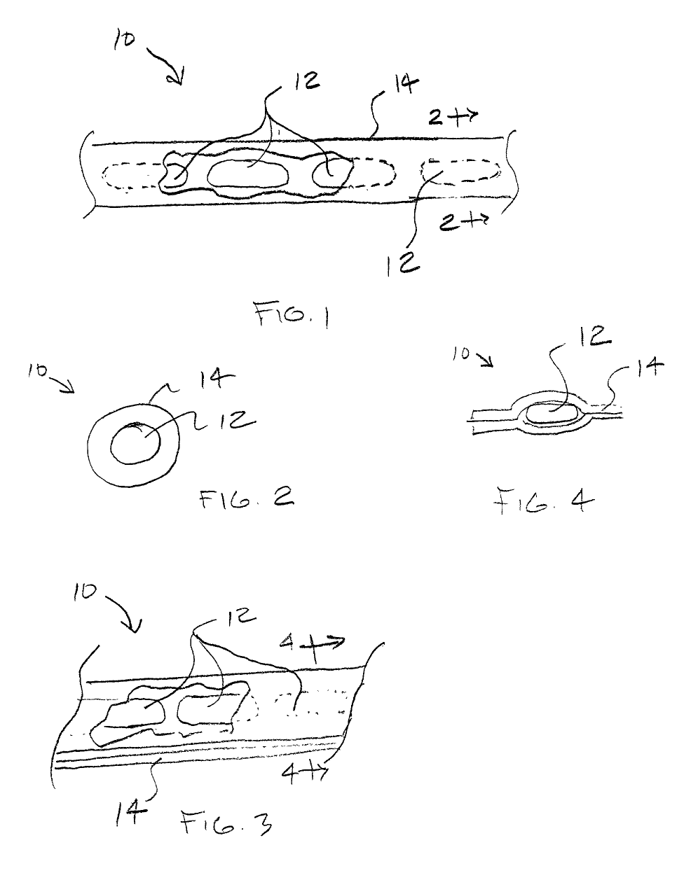

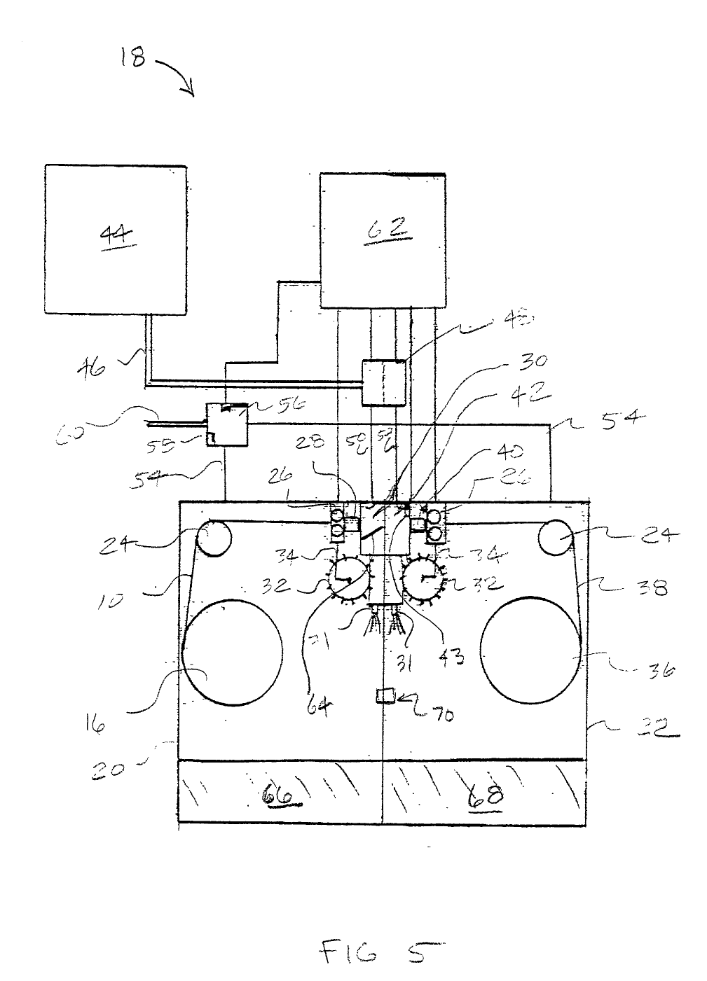

Referring to FIG. 1, the reference numeral 10 refers in general to a fuel source for use in connection with the present invention. The fuel source 10 comprises a chemical hydride core 12 and an elongate, flexible moisture barrier 14. The chemical hydride is preferably a metal hydride, is more preferably an alkali hydride, and is most preferably NaH or NaBH₄. The core 12 is formed by a plurality of discrete chemical hydride bodies. The barrier 14 is a thermoplastic, such as a high density polyethylene, polyvinyl chloride, or a UHMW plastic. The fuel source 10 may be formed by any number of known technique, such as using coextrusion in a “dry” Nitrogen room. As seen in FIG. 3, in an alternate embodiment, the fuel source 10 may be formed by sandwiching the core 12 between two ribbons that provide a moisture tight seal to prevent hydrolysis of the core 12. The barrier 14 is flexible and long enough to permit the fuel source 10 to be wrapped around a spool 16. Although the core 12 is described as being formed by a plurality of discrete bodies, it is understood that the core 12 may be a continuous piece. Also, although the core 12 is described as being a chemical hydride, it is understood that the spooled, moisture barrier 14 encasing may be applied to a wide variety of materials, particularly materials that are highly reactive with hydrogen, oxygen, or water vapor.

Referring to FIG. 5, the reference numeral 18 refers to a hydrogen generator of the present invention. Storage chambers 20 and 22 are provided and may be separate tanks or chambers or may be a single two-chamber vessel. Spool 16 is positioned within chamber 20. Fuel source 10 is coiled on spool 16. From the spool 16, the fuel source 10 passes over idler wheel 24, to feed wheels 26, through a jacket stripper and guide 28, and to a reaction chamber 30. A nozzle 31 is provided in a lower portion of the reaction chamber 30. A turbine wheel and spring assembly 32 and mechanical drive 34 are connected to the feed wheels 26.

Similarly, spool 36 is positioned in chamber 22. From the spool 36, aluminum wire 38 passes over idler wheel 24, to feed wheels 26, through a guide 40, and to a reaction chamber 42. Because the aluminum wire 38 is not jacketed, a guide 40 may be used rather than a jacket stripper and guide 28. A nozzle 31 is provided in a lower portion of the reaction chamber 42. A temperature sensor 43 is provided in reaction chamber 42. A turbine wheel and spring assembly 32 and mechanical drive 34 are connected to the feed wheels 26.

A water tank or source 44 is provided. Water passes via line 46 to a dual mode water pump 48 and then passes under pressure via conduits 50 and 52 to reaction chambers 30 and 42 respectively. Lines 54 exit upper portions of the chambers 20 and 22 and pass to a pressure sensor 56, having a gas balance valve 58. Line 60 passes from sensor 56. A control system 62 is provided for sending and receiving signals to and from the pressure sensor 56, the feed wheels 26, the pump 48, and the temperature sensor 43.

In operation, in chamber 20, the turbine wheel and spring assembly 32 and mechanical drive 34 power the feed wheels 26 to advance the fuel source 10 from the spool 16, over the idler wheel 24, and to and through the feed wheels 26. The feed wheels 26 drive the source 10 through the jacket stripper and guide that uses a blade to strip the protective barrier 14 and expose the chemical hydride 12. The stripped barrier 14 falls to a lower portion of chamber 20. Stripping the barrier 14 from the core 12 allows the discharge of a desired number of discrete chemical hydride bodies 12 into reaction chamber 30 based upon the amount of hydrogen gas needed. Water is supplied from water source 44 and is metered into the reaction chamber 30 using pump 48 to provide water in an amount that is greater than stoichiometric requirements for the reaction with the chemical hydride.

In one preferred embodiment, the chemical hydride is NaH, and it is hydrolyzed in the reaction chamber 30 according to the following reaction: NaH+H₂O→NaOH+H₂. In another preferred embodiment, the chemical hydride is NaBH₄. When NaBH₄ is used, a palladium catalyst 64 is provided in the reaction chamber as a catalyst to the following reaction: NaBH₄+2H₂O→NaBO₂+4H₂. The pressurized hydrogen gas and the reaction products are discharged through nozzle 31 into chamber 20. A pressure and temperature drop provides a safe operating temperature and pressure of the storage tank 20. The reaction chamber 30 is thermally insulated from the remainder of the internal area of the hydrogen storage tank 20. The kinetic energy of the resultant pressurized hydrogen is used to drive the turbine wheel and spring assembly 32 which stores spring type energy to advance the fuel source 10 to the reaction chamber 30 upon later demand. The chamber 20 contains pieces of the stripped barrier 14, hydrogen gas, aqueous NaOH and H₂O. The solution 66 in the bottom of chamber 20 is approximately an 80% aqueous NaOH solution or an 80% NaBH₄ solution, depending upon the composition of the core 12 and the amount of water provided. Upon demand, hydrogen gas is passed from the tank 20, through line 54, through pressure sensor 56, and through supply line 60.

Reaction chamber 42 in chamber 22 is operated in a manner similar to reaction chamber 30 in chamber 20. The turbine wheel and spring assembly 32 and mechanical drive 34 power the feed wheels 26 to advance the aluminum wire 38 from the spool 36, over the idler wheel 24, and to and through the feed wheels 26. The feed wheels drive the wire 38 through the guide 40 and into reaction chamber 42. Water is supplied from water source 44 and is metered into the reaction chamber 42 using pump 48 to provide water in an amount that is greater than stoichiometric requirements for the reaction with the aluminum. In the limited volume of the adjacent reaction chamber 30, exothermic heat and heat induced from rising pressures is generated. This heat is transferred by conduction to reaction chamber 42 where aluminum wire 38 and water are to be reacted. When sufficient heat is transferred to produce a temperature of approximately 180° C. and a pressure of approximately 300 psi in the reaction chamber 42, the aluminum decomposes according to the reaction: 2Al+3H₂O→Al₂O₃+3H₂. This reaction significantly boosts the hydrogen gas output of the hydrogen generator 18. A heating element (not shown) may be provided in or adjacent to reaction chamber 42 to help obtain and maintain the desired temperature.

The pressurized hydrogen gas and the reaction products are discharged through nozzle 31 into chamber 22. A pressure and temperature drop provides a safe operating temperature and pressure of the storage tank 22. The reaction chamber 42 is thermally insulated from the remainder of the internal area of the hydrogen storage tank 22. The kinetic energy of the resultant pressurized hydrogen is used to drive the turbine wheel and spring assembly 32 which stores spring type energy to advance the aluminum wire 38 to the reaction chamber 42 upon later demand. The chamber 22 contains hydrogen gas, aqueous Al₂O₃ and H₂O. The solution 68 in the bottom of chamber 22 is approximately an 80% aqueous Al₂O₃ depending upon the amount of water provided. Upon demand, hydrogen gas is passed from the tank 22, through line 54, through pressure sensor 56, and through supply line 60. The chambers 20 and 22 act as hydrogen gas buffers for varying hydrogen loads placed on the system. The chambers 20 and 22 also maintain separation of the products of reaction from the reaction chambers 30 and 42 for ease of reclamation. A crossover valve 70 maintains substantially equal pressures in the chambers 20 and 22. The controller 62 may monitor the hydrogen gas pressure at pressure sensor 56 and may feed additional fuel source 10, aluminum wire 38, and water into reaction chambers 30 and 42 as needed to achieve and maintain a desired hydrogen gas pressure. It is of course understood that either reaction chamber 30 or 42 may be used independently of the other, and the hydrogen generator 18 may omit one or the other.

The present invention provides for convenient, safe and practical shipping, storing and handling of fuels for a hydrogen generator 18 and provides for improved hydrogen generator efficiencies. Additionally on all scales of implementation, the spooled packaging system provides for a much simpler metered feed of the chemical hydrides with the water. Additionally the continuous spool reduces the chances of fouled mechanical processing.

Other modifications, changes and substitutions are intended in the foregoing, and in some instances, some features of the invention will be employed without a corresponding use of other features. For example, the fuel source 10 of may be used in connection with any number of different types and kinds of hydrogen generators. Similarly, the hydrogen generator 18 may use any of a wide variety of types and forms of fuels. The fuel source 10 need not be provided on a spool and need not take any particular size or shape. The fuel source 10 and generator 18 may also be provided in a wide variety of sizes, ranging from the smallest portable applications to large scale, fixed industrial applications. Accordingly, it is appropriate that the appended claims be construed broadly and in a manner consistent with the scope of the invention.

What is claimed is:

1. A device, comprising:
a chemical hydride core; and
an elongate moisture barrier encasing said core, said barrier being of sufficient length and flexibility to be wrapped around a spool.

2. The device of claim 1, wherein said core comprises a plurality of discrete chemical hydride bodies.

3. The device of claim 2, further comprising:
a spool, said barrier being wrapped around said spool.

4. The device of claim 2, wherein said plurality of discrete chemical hydride bodies comprise one or more alkali hydrides.

5. The device of claim 2, wherein said plurality of discrete chemical hydride bodies are selected from the group consisting of NaH and NaBH₄.

6. The device of claim 2 wherein said barrier comprises a thermoplastic.

7. A device comprising:
a plurality of discrete chemical hydride bodies; and
an elongate moisture barrier encasing said plurality of said bodies, said barrier being of sufficient length and flexibility to be wrapped around a spool.

8. The device of claim 7, wherein said barrier comprises a thermoplastic.

9. The device of claim 8, wherein said plurality of discrete chemical hydride bodies comprise one or more alkali hydrides.

10. The device of claim 7 wherein said plurality of discrete chemical hydride bodies are selected from the group consisting of NaH and NaBH₄.

11. A device, comprising:
a reaction chamber;
a spool;
a fuel source wrapped around said spool, said fuel source comprising a chemical hydride core and an elongate moisture barrier encasing said core, said fuel source passing from said spool to said reaction chamber; and
means for removing said barrier from said core for reaction of said core within said reaction chamber.

12. The device of claim 11, wherein said chemical hydride core is selected from the group consisting of NaH and NaBH₄.

13. The device of claim 12, wherein said barrier comprises a thermoplastic.

14. The device of claim 11, further comprising a storage chamber operably connected to said reaction chamber for receiving and storing reaction products from said reaction chamber.

15. The device of claim 11, further comprising:
a second reaction chamber;
an aluminum feedstock; and
means for supplying said aluminum feedstock and H₂O to said second reaction chamber.

16. A method of generating H₂ gas, comprising:
(a) providing a fuel source comprising first and second discrete chemical hydride bodies, and an elongate moisture barrier encasing said first and second discrete chemical hydride bodies;
(b) removing a first portion of said barrier to expose said first discrete chemical hydride body; and
(c) reacting said exposed first discrete chemical hydride body with H₂O.

17. The method of claim 16, further comprising:
after step (c), removing a second portion of said barrier to expose said second discrete chemical hydride body; and
reacting said exposed second discrete chemical hydride body with H₂O.

18. The method of claim 16, wherein said first portion of said barrier is stored on a spool, and further comprising:
before step (b), unrolling said first portion of said barrier from said spool.

19. The method of claim 16, wherein step (c) takes place in a first reaction chamber, and further comprising:
transferring heat from said first reaction chamber to a second reaction chamber;
passing Al and H₂O into said second reaction chamber; and
reacting said Al and H₂O in said second reaction chamber.

20. The method of claim 18, further comprising:
before reacting said Al and H₂O, obtaining a temperature in said second reaction chamber that is substantially within a range of from approximately 170° C. to approximately 210° C.
